(19) United States
(12) Patent Application Publication
(10) Pub. No.: US 2022/0059929 A1
(43) Pub. Date: Feb. 24, 2022

(54) BASE STATION ANTENNA RADIATOR HAVING FUNCTION FOR SUPPRESSING UNWANTED RESONANCES

(71) Applicant: ACE TECHNOLOGIES CORPORATION, Incheon (KR)

(72) Inventors: Bayanmunkh ENKHBAYAR, Incheon (KR); Ho-Yong KIM, Incheon (KR); Eun Hyuk KWAK, Incheon (KR); Jae Hoon TAE, Incheon (KR)

(73) Assignee: ACE TECHNOLOGIES CORPORATION

(21) Appl. No.: 17/521,365

(22) Filed: Nov. 8, 2021

Related U.S. Application Data
(63) Continuation of application No. PCT/KR2020/006013, filed on May 7, 2020.

(30) Foreign Application Priority Data
May 10, 2019 (KR) 10-2019-0054729

(51) Int. Cl. H01Q 1/24; H01Q 9/04

(52) U.S. Cl. CPC H01Q 1/246; H01Q 9/0457

(57) ABSTRACT

A base station antenna radiator comprises: a first balun substrate, on an upper surface of which a feed line, a first C-coupling member, and a first inductive filter line connected to the first C-coupling member, and on a lower surface of which a third C-coupling member opposite to the first C-coupling member and a third inductive filter line electrically connected to the first inductive filter line through a first via hole and connected to the third C-coupling member are formed, the first balun substrate being placed perpendicular to a reflector; a second balun substrate coupled orthogonally to the first balun substrate, and on which a metal pattern substantially identical to that of the first balun substrate is formed; and a radiating substrate disposed above the first and second balun substrates, placed parallel to the reflector, and on an upper surface of which at least one radiating patch is formed.

### CROSS-REFERENCE TO RELATED APPLICATIONS

This application is a Bypass Continuation of pending PCT International Application No. PCT/KR2020/006013, which was filed on May 7, 2020, and which claims priority from Korean Patent Application No. 10-2019-0054729 filed on May 10, 2019. The entire contents of the aforementioned patent applications are incorporated herein by this reference.

### BACKGROUND

### 1. Technical Field

The present disclosure relates to a base station antenna radiator, more particularly to a base station antenna radiator having function for suppressing unwanted resonances.

### 2. Description of the Related Art

The base station antenna is an antenna installed in the base station to transmit and receive signals to and from terminals within a preset radius. With the introduction of the 5G system, as a relatively high-frequency band is used for communication, multi-band radiation characteristics are required for the base station antenna, and for this reason, in the base station antenna, a plurality of radiators radiating in different frequency bands are disposed together in one base station antenna.

The radiation frequency of the base station antenna is determined by the size of the radiator of the antenna. However, if the power feeding and impedance matching are performed by a metal pattern, a problem arises that the boundary between the radiator and the feeding line is ambiguous. If a radiator for high-frequency radiation and a radiator for low-frequency radiation are included in one antenna device, due to such ambiguity, a problem occurred in that the signal radiated from a low-frequency radiator was induced in the high-frequency radiator and resonated.

Although the size of the high-frequency radiator is set appropriately for high-frequency, unwanted resonances occur since the feed pattern and the radiator are combined. In order to solve this problem, a structure using a dual reflector has been proposed, but this structure has a problem of increasing the size of the antenna.

FIG. 1 shows an upper surface structure of the balun substrate used in the conventional base station antenna radiator, and FIG. 2 shows a lower surface structure of the balun substrate used in the conventional base station antenna radiator.

Referring to FIG. 1, a feed line 100 is formed on the upper surface of the conventional balun substrate, and the feed line 100 receives a feed signal using a cable or the like.

A first feeding pattern 200 and a second feeding pattern 210 are formed on the lower surface of the balun substrate, wherein the first feeding pattern 200 and the second feeding pattern 210 independently receive coupling feed from the feed line 100 and provide a feed signal to the radiator (not shown), the first ends of the first feeding pattern 200 and the second feeding pattern 210 are electrically connected to the radiator, and the second ends are electrically connected to an element having a ground potential, such as a reflector.

As described above, such a structure of the conventional balun substrate has a problem of generating unwanted resonances of a low-frequency band in a high-frequency radiator.

### SUMMARY

An object of the present disclosure is to propose a base station antenna radiator structure capable of suppressing unwanted resonances in a base station antenna in which a low-frequency radiator and a high-frequency radiator are provided together.

To achieve the objective above, an aspect of the present disclosure provides a base station antenna radiator, comprising: a first balun substrate, on an upper surface of which a feed line, a first C-coupling member spaced apart from the feed line, and a first inductive filter line connected to the first C-coupling member and having a narrower width than the first C-coupling member are formed, and on a lower surface of which a third C-coupling member opposite to the first C-coupling member and a third inductive filter line electrically connected to the first inductive filter line through a first via hole and connected to the third C-coupling member are formed, the first balun substrate being placed perpendicular to a reflector; a second balun substrate coupled orthogonally to the first balun substrate, placed perpendicular to the reflector, and on which a metal pattern substantially identical to that of the first balun substrate is formed; and a radiating substrate disposed above the first balun substrate and the second balun substrate, placed parallel to the reflector, and on an upper surface of which at least one radiating patch is formed, wherein an end of the first C-coupling member is electrically connected to the radiating patch, and an end of the third C-coupling member is electrically connected to the reflector or an element having a ground potential.

The first balun substrate and the second balun substrate include a first protrusion protruding upward, and the first protrusion protrudes above the radiating substrate through slots formed in the radiating substrate.

A first extension extending along the first protrusion is formed on the first C-coupling member and electrically connected to the radiating patch.

The first balun substrate and the second balun substrate include a second protrusion protruding downward, wherein a third extension of the third C-coupling member extends along the second protrusion and electrically connected to the reflector or the element having a ground potential.

A +45 degree polarization signal is fed to the feed line of the first balun substrate, and a −45 degree polarization signal is fed to the feed line of the second balun substrate.

On the upper surface of the first balun substrate, a second C-coupling member and a second inductive filter line are further formed, the second C-coupling member being spaced apart from the first C-coupling member and having a symmetric structure with the first C-coupling member, and the second inductive filter line being connected to the second C-coupling member, having a narrower width than that of the second C-coupling member, and having a symmetric structure with the first inductive filter line.

On the lower surface of the first balun substrate, a fourth C-coupling member and a fourth inductive filter line are further formed, the fourth C-coupling member being spaced apart from the third C-coupling member and having a symmetric structure with the third C-coupling member, and the fourth inductive filter line being connected to the fourth C-coupling member, being electrically connected to the second inductive filter line through a second via hole, and having a symmetric structure with the third inductive filter line.

Another aspect of the present disclosure provides a base station antenna radiator, comprising: a first balun substrate, on an upper surface of which a feed line, a first C-coupling member spaced apart from the feed line, and a second C-coupling member spaced apart from the feed line and the first C-coupling member and having a symmetric structure with the first C-coupling member are formed, and on a lower surface of which a third C-coupling member opposite to the first C-coupling member and a fourth C-coupling member opposite to the second C-coupling member and having a symmetric structure with the third C-coupling member are formed, the first balun substrate being placed perpendicular to a reflector; a second balun substrate coupled orthogonally to the first balun substrate, placed perpendicular to the reflector, and on which a metal pattern substantially identical to that of the first balun substrate is formed; and a radiating substrate disposed above the first balun substrate and the second balun substrate, placed parallel to the reflector, and on an upper surface of which at least one radiating patch is formed, wherein an end of the first C-coupling member is electrically connected to the radiating patch, and an end of the third C-coupling member is electrically connected to the reflector or an element having a ground potential.

There is an advantage in that unwanted resonances can be suppressed in a base station antenna of the present disclosure in which a low-frequency radiator and a high-frequency radiator are provided together.

### BRIEF DESCRIPTION OF THE DRAWINGS

FIG. 1 shows an upper surface structure of a balun substrate used in a conventional base station antenna radiator.

FIG. 2 shows a lower surface structure of a balun substrate used in a conventional base station antenna radiator.

FIG. 3 is a perspective view showing a structure of a base station antenna radiator according to an embodiment of the present disclosure.

FIG. 4 is a perspective view of a state in which the upper radiating substrate is removed from a base station antenna radiator according to an embodiment of the present disclosure.

FIG. 5 shows an upper surface structure of a first balun substrate according to an embodiment of the present disclosure.

FIG. 6 shows a lower surface structure of a first balun substrate according to an embodiment of the present disclosure.

FIG. 7 shows an upper surface structure of a second balun substrate according to an embodiment of the present disclosure.

FIG. 8 shows a lower surface structure of a second balun substrate according to an embodiment of the present disclosure.

FIG. 9 shows a structure of a base station antenna using a base station antenna radiator according to an embodiment of the present disclosure.

FIG. 10 is a perspective view showing a structure of a base station antenna radiator according to another embodiment of the present disclosure.

### DETAILED DESCRIPTION

The present disclosure is described in detail below with reference to the accompanying drawings. However, the disclosure can be implemented in various different forms and thus is not limited to the embodiments described herein.

For a clearer understanding of the invention, parts that are not of great relevance to the invention have been omitted from the drawings, and like reference numerals in the drawings are used to represent like elements throughout the specification.

Throughout the specification, when it is described that a part is “connected” with another part, the part may be “directly connected” with the other part or “indirectly connected” with the other part possibly through a third part.

In addition, reference to a part “including” or “comprising” an element does not preclude the existence of one or more other elements and can mean other elements are further included, unless there is specific mention to the contrary.

Embodiments of the present disclosure is described in detail below with reference to the accompanying drawings.

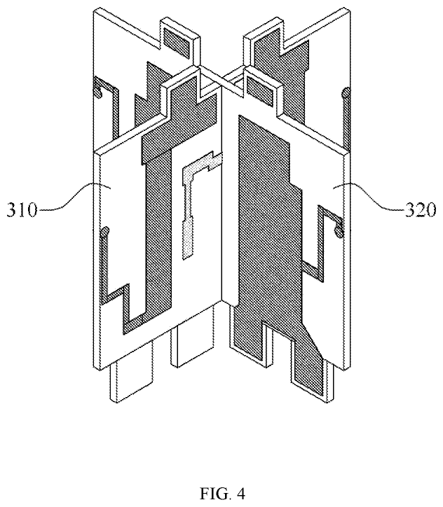

FIG. 3 is a perspective view showing a structure of a base station antenna radiator according to an embodiment of the present disclosure, and FIG. 4 is a perspective view of a state in which the upper radiating substrate is removed from a base station antenna radiator according to an embodiment of the present disclosure.

Referring to FIG. 3, the base station antenna radiator according to an embodiment of the present disclosure includes a radiating substrate 300, a first balun substrate 310 and a second balun substrate 320.

The radiating substrate 300 performs a function of radiating an RF signal in the base station antenna radiator according to an embodiment of the present disclosure, and at least one radiating patch 325 for radiating the RF signal is formed on the radiating substrate 300.

Referring to FIG. 3, the radiating patch 325 is formed on the upper surface of the radiating substrate 300, and for example, four radiating patches are formed. It will be apparent to those skilled in the art that the number of radiating patches and the shape of the radiating patches may be variously changed based on the required radiation pattern and resonance frequency.

The first balun substrate 310 and the second balun substrate 320 provide a feed signal to the radiating patch 325 and perform impedance matching.

The first balun substrate 310 and the second balun substrate 320 are placed perpendicular to a reflector (not shown) of the base station antenna, and a feed signal is provided to the first balun substrate 310 and the second balun substrate 320.

Referring to FIG. 4, the first balun substrate 310 and the second balun substrate 320 are placed perpendicular to a reflector (not shown) so as to cross each other to form a cross shape. As an example, slots for crossing in a cross shape may be formed in the first balun substrate 310 and the second balun substrate 320. Meanwhile, the radiating substrate 300 is placed parallel to the reflector (not shown), while being coupled to upper portions of the first balun substrate 310 and the second balun substrate 320.

On the upper and lower surfaces of the first balun substrate 310, metal patterns are formed for feeding +45 degree polarization signal to the radiating patch 325 and impedance matching. In addition, on the upper and lower surfaces of the second balun substrate 320, metal patterns are formed for feeding −45 degree polarization signal to the radiating patch 325 and impedance matching.

It is preferable that metal patterns of substantially the same shape are formed on the first balun substrate 310 and the second balun substrate 320, but if necessary, structures of the metal patterns formed on both substrates may be different.

The radiating patches 325 formed on the radiating substrate 300 simultaneously radiate a +45 degree polarization signal and a −45 degree polarization signal provided through the first balun substrate 310 and the second balun substrate 320.

The present disclosure assumes that the base station antenna radiator as shown in FIG. 3 and a low-frequency radiator radiating in a lower band than the radiator shown in FIG. 3 exist together on the reflector of the antenna.

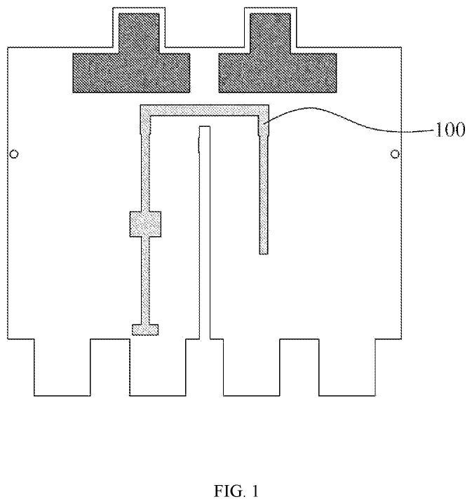

The conventional base station antenna radiator as shown in FIG. 1 is a radiator set to radiate a relatively high-frequency signal compared to a low-frequency radiator, but due to various reasons, there was a problem in that the signal radiated from the low-frequency radiator was induced in the high-frequency radiator (base station antenna radiator shown in FIG. 1), causing unwanted resonances.

The main cause of such unwanted resonances is that the overall length of the metal patterns for power feeding and impedance matching formed on the radiating patch and the balun substrate is similar to the radiation frequency of the low-frequency radiator, so that low-frequency resonance occurs. In order to avoid interference of low-frequency and high-frequency signals, low-frequency resonance in a high-frequency radiator should be suppressed, however the conventional base station antenna radiator as shown in FIG. 1 had a problem in that it could not properly suppress resonance of a low-frequency signal.

In order to solve this problem, the present disclosure proposes a power feeding and impedance matching structure of the balun substrates 310 and 320 capable of suppressing unintended low-frequency resonances, and the proposed feeding and impedance matching structure is formed on upper and lower surfaces of the first balun substrate 310 and the second balun substrate 320.

Meanwhile, a plurality of base station antenna radiators according to the embodiment of the present disclosure as shown in FIG. 3 and low-frequency radiators affecting the radiator of the present disclosure may be arranged while having an array structure. In this case, as each radiator, a phase shifter may be used to adjust the phase of a fed signal.

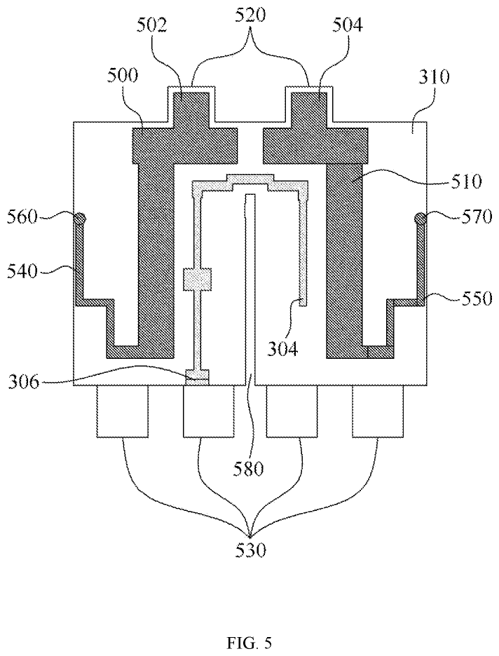

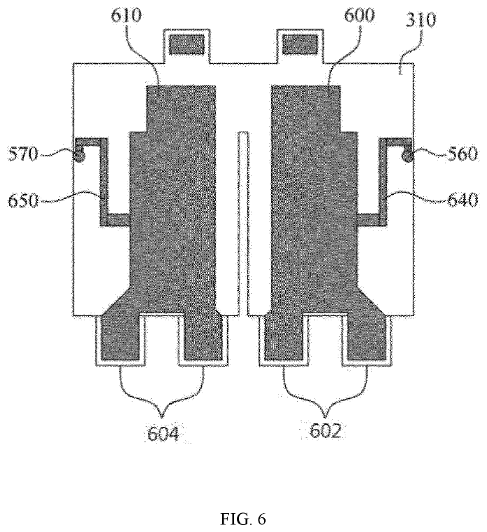

FIG. 5 shows an upper surface structure of a first balun substrate according to an embodiment of the present disclosure, and FIG. 6 shows a lower surface structure of a first balun substrate according to an embodiment of the present disclosure.

Referring to FIG. 5 and FIG. 6, a feed line 304 is formed on the upper surface of the first balun substrate 310. The feed line 304 is electrically connected to a feed point 306. The feed line 304 may have a partially different width, and such a structure is for impedance matching.

The feed point 306 may be connected to an external cable or metal pattern that provides a feed signal. For example, when a feed signal is provided through a coaxial cable, the feed point 306 may be connected to an inner core of the coaxial cable.

A first C-coupling member 500 and a second C-coupling member 510 are formed on the upper surface of the first balun substrate 310. The first C-coupling member 500 and the second C-coupling member 510 have substantially the same structure. The first C-coupling member 500 and the second C-coupling member 510 are preferably arranged in a left-right symmetrical form with respect to the feed line. The first C-coupling member 500 and the second C-coupling member 510 are disposed to be spaced apart from the feed line 304.

On the first balun substrate 310, two first protrusions 520 are formed upward, and four second protrusions 530 are formed downward. Of course, the number of the protrusions 520 and 530 may be variously changed in consideration of required characteristics, size of the radiator, and the like.

The first C-coupling member 500 and the second C-coupling member 510 include a first extension 502 and a second extension 504 extending in a protruding direction of the first protrusions 520. The first protrusions 520 protrude through slots formed in the radiating substrate 300, and the extensions 502 and 504 of the first C-coupling member 500 and the second C-coupling member 520 also protrude through the slots.

Eventually, the first extension 502 and the second extension 504 are electrically coupled to the radiating patches 325 formed on the radiating substrate 300, which means that the first ends of the first C-coupling member 500 and the second C-coupling member 510 are electrically coupled to the radiating patches 325.

Meanwhile, the second ends of the first C-coupling member 500 and the second C-coupling member 510 are coupled to the first inductive filter line 540 and the second inductive filter line 550, respectively.

As shown in FIG. 5, the first inductive filter line 540 and the second inductive filter line 550 have a metal pattern structure in the form of a line, wherein the first inductive filter line 540 has a narrow width compared to the first C-coupling member 500, and the second inductive filter line 550 has a narrow width compared to the second C-coupling member 510.

The first inductive filter line 540 and the second inductive filter line 550 preferably have a symmetrical structure, but are not limited thereto. A first via hole 560 and a second via hole 570 are respectively formed at the end of the first inductive filter line 540 and the end of the second inductive filter line 550.

A first slot 580 is formed in a central portion of the first balun substrate 310, and the first slot 580 is formed for orthogonal coupling between the first balun substrate 310 and the second balun substrate 320.

Referring to FIG. 6, a third C-coupling member 600 and a fourth C-coupling member 610 are formed on a lower surface of the first balun substrate 310. The third C-coupling member 600 and the fourth C-coupling member 610 are respectively formed on the left and right sides of the center of the first balun substrate 310. The third C-coupling member 600 and the fourth C-coupling member 610 preferably have a symmetrical structure.

The third C-coupling member 600 on the lower surface of the substrate is positioned to face the first C-coupling member 500 on the upper surface, and the fourth C-coupling member 610 on the lower surface of the substrate is positioned to face the second C-coupling member 510 on the upper surface.

The third C-coupling member 600 includes a third extension 602 extending along the second protrusion 530 of the first balloon substrate 310. Although two third extensions 602 are illustrated in FIG. 6, the number of third extensions 602 may be changed according to required characteristics. The third extension 602 may be electrically connected to a reflector (not shown) or another element having a ground potential.

The fourth C-coupling member 610 includes a fourth extension 604 extending along the second protrusion 530 of the first balloon substrate 310. The number of fourth extensions 604 may also be changed according to required characteristics. The fourth extension 604 may also be electrically connected to a reflector (not shown) or another element having a ground potential.

The first C-coupling member 500 and the third C-coupling member 600 positioned to face each other operate as one capacitive filter. The second C-coupling member 510 and the fourth C-coupling member 610 positioned to face each other also operate as a single capacitive filter.

The first C-coupling member 500 operating as a capacitive filter is electrically connected to the radiating patch, and the third C-coupling member 600 opposite thereto is electrically connected to a reflector or an element having a ground potential. The second C-coupling member 510 is also directly connected to the radiating patch, and the fourth C-coupling member 610 opposite thereto is electrically connected to a reflector or an element having a ground potential.

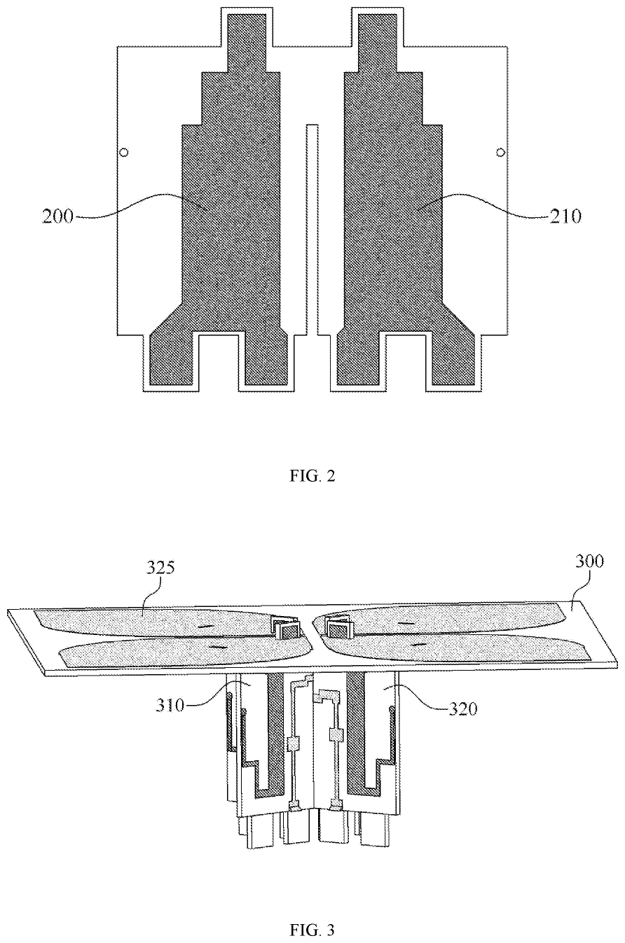

Such a structure of the present disclosure is different from a structure of the conventional radiator of FIG. 1 and FIG. 2 in which one member is connected to the radiator and a reflector.

The capacitive filter consisting of the first C-coupling member 500 and the third C-coupling member 600 acts as a capacitive filter which passes a feed signal for a frequency band intended by the radiator of the present disclosure.

Meanwhile, a third inductive filter line 640 and a fourth inductive filter line 650 are coupled to each of the third C-coupling member 600 and the fourth C-coupling member 610. The third inductive filter line 640 is electrically connected to the first inductive filter line 540 on the upper surface through the first via hole 560. The fourth inductive filter line 650 is electrically connected to the second inductive filter line 550 on the upper surface through the second via hole 570.

The third inductive filter line 640 has a narrow width compared to that of the third C-coupling member 600, and the fourth inductive filter line 650 has a narrow width compared to that of the fourth C-coupling member 610.

The first inductive filter line 540 and the third inductive filter line 640 electrically connected to each other function as one inductive filter, and the second inductive filter line 550 and the fourth inductive filter line 650 electrically connected to each other function as one inductive filter.

Resonances in the unwanted frequency region (low-frequency region compared to the intended radiation band of the antenna of the present disclosure) can be primarily blocked by a capacitive filter composed of the first C-coupling member 500 and the third C-coupling member 600 or a capacitive filter composed of the second C-coupling member 510 and the fourth C-coupling member 610. However, resonances that are not blocked only by the capacitive filter is blocked by the inductive filter.

The inductive filter composed of the first inductive filter line 540 and the third inductive filter line 640 or the inductive filter composed of the second inductive filter line 550 and the fourth inductive filter line 650 changes the resonance frequency of the low-frequency resonance that may occur in the first balun substrate 310 to a frequency of a lower region, thereby blocking unwanted resonances caused by the adjacent low-frequency radiator.

In FIG. 5 and FIG. 6, the capacitive filter composed of the first C-coupling member 500 and the third C-coupling member 600 and the inductive filter composed of the first inductive filter line 540 and the third inductive filter line 640 independently provide a feed signal to the radiating patch, and the capacitive filter composed of the second C-coupling member 510 and the fourth C-coupling member 610 and the inductive filter composed of the first inductive filter line 550 and the third inductive filter line 650 independently provide a feed signal to the radiating patch.

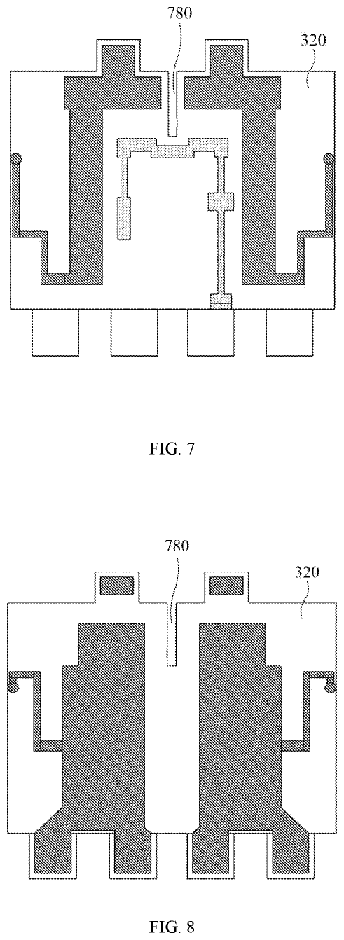

FIG. 7 shows an upper surface structure of a second balun substrate according to an embodiment of the present disclosure, and FIG. 8 shows a lower surface structure of a second balun substrate according to an embodiment of the present disclosure.

The second balun substrate 320 shown in FIG. 7 and FIG. 8 is a substrate for providing a feed signal of −45 degree polarization, and since the shape of the metal pattern formed on the second balun substrate 320 is substantially the same as that of the metal pattern formed on the first balun substrate 310, a description of the structure and function of the metal pattern will be omitted.

However, a second slot 780 formed in the second balun substrate 320 is formed at a different position from the first slot 580 of the first balun substrate 310. The first balun substrate 310 and the second balun substrate 320 are orthogonally coupled to each other through the first slot 580 and the second slot 780.

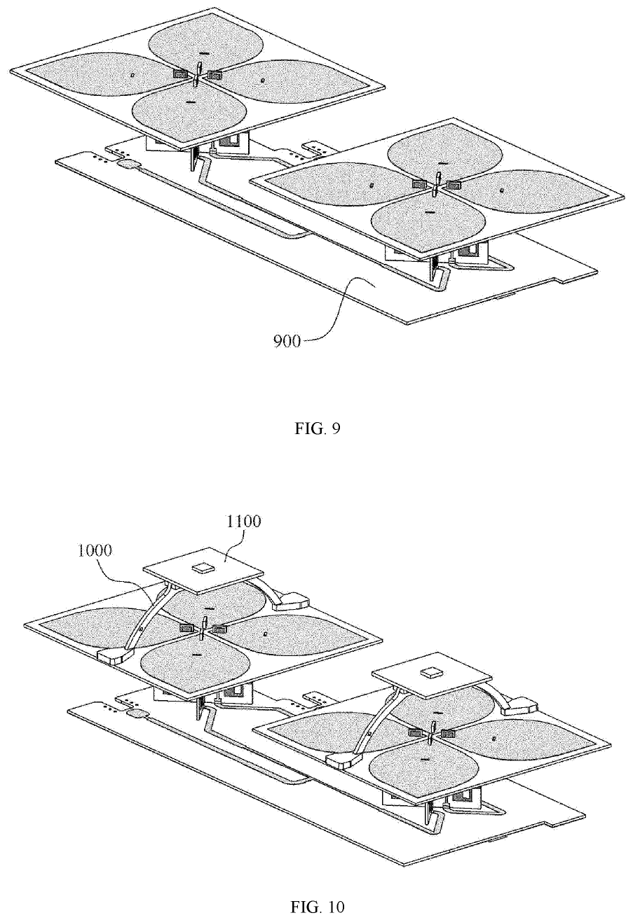

FIG. 9 shows a structure of a base station antenna using a base station antenna radiator according to an embodiment of the present disclosure.

Referring to FIG. 9, a plurality of radiators are arranged on a reflector 900 of the base station antenna. A +45 degree polarization signal and a −45 degree polarization signal are fed to each of the plurality of radiators forming an array, and a phase shifter may be used to adjust the phase of the signal fed to each of the plurality of radiators.

FIG. 10 is a perspective view showing a structure of a base station antenna radiator according to another embodiment of the present disclosure.

The base station antenna radiator according to another embodiment of the present disclosure shown in FIG. 10 further includes a parasitic patch support unit 1000 and a parasitic patch 1100 compared to the base station antenna radiator shown in FIG. 3.

The parasitic patch 1100 is supported by the parasitic patch support unit 1000 and is disposed above the radiating substrate 300 to be spaced apart from the radiating substrate 300. The parasitic patch 1100 is preferably disposed on the central portion of the radiating substrate 300.

The parasitic patch 1100 may be disposed to improve the degree of isolation between polarizations. The base station antenna radiator of the present disclosure uses a double polarization feed, and the cross polarization ratio can be improved due to the parasitic patch 1100.

The description of the present disclosure provided above is illustrative; it is to be appreciated that a person of ordinary skill in the field of art to which the invention pertains can easily provide modifications implemented in specific forms without departing from the technical spirit of the invention or altering the essential features of the invention.

Thus, it should be understood that the embodiments disclosed in the foregoing are illustrative in all aspects and do not limit the scope of the present disclosure.

For example, an element described as having an integrated form can be implemented in a distributed form, and likewise, an element described as having a distributed form can be implemented in an integrated form.

The scope of the present disclosure is to be defined by the scope of claims provided below, and all variations or modifications that can be derived from the meaning and scope of the claims as well as their equivalents are to be interpreted as being encompassed within the scope of the present disclosure.

What is claimed is:

1. A base station antenna radiator, comprising:
a first balun substrate, on an upper surface of which a feed line, a first C-coupling member spaced apart from the feed line, and a first inductive filter line connected to the first C-coupling member and having a narrower width than the first C-coupling member are formed, and on a lower surface of which a third C-coupling member opposite to the first C-coupling member and a third inductive filter line electrically connected to the first inductive filter line through a first via hole and connected to the third C-coupling member are formed, the first balun substrate being placed perpendicular to a reflector;
a second balun substrate coupled orthogonally to the first balun substrate, placed perpendicular to the reflector, and on which a metal pattern substantially identical to that of the first balun substrate is formed; and
a radiating substrate disposed above the first balun substrate and the second balun substrate, placed parallel to the reflector, and on an upper surface of which at least one radiating patch is formed,
wherein an end of the first C-coupling member is electrically connected to the radiating patch, and an end of the third C-coupling member is electrically connected to the reflector or an element having a ground potential.

2. The base station antenna radiator according to claim 1,
wherein the first balun substrate and the second balun substrate include a first protrusion protruding upward, and the first protrusion protrudes above the radiating substrate through slots formed in the radiating substrate, and a first extension extending along the first protrusion is formed on the first C-coupling member and electrically connected to the radiating patch.

3. The base station antenna radiator according to claim 1,
wherein the first inductive filter line is formed extending from another end of the first C-coupling member.

4. The base station antenna radiator according to claim 2,
wherein the first balun substrate and the second balun substrate include a second protrusion protruding downward, and wherein a third extension of the third C-coupling member extends along the second protrusion and electrically connected to the reflector or the element having a ground potential.

5. The base station antenna radiator according to claim 1,
wherein a +45 degree polarization signal is fed to the feed line of the first balun substrate, and a −45 degree polarization signal is fed to the feed line of the second balun substrate.

6. The base station antenna radiator according to claim 1,
wherein on the upper surface of the first balun substrate, a second C-coupling member and a second inductive filter line are further formed, wherein the second C-coupling member is spaced apart from the first C-coupling member and has a symmetric structure with the first C-coupling member, and wherein the second inductive filter line is connected to the second C-coupling member, has a narrower width than that of the second C-coupling member, and has a symmetric structure with the first inductive filter line.

7. The base station antenna radiator according to claim 6,
wherein on the lower surface of the first balun substrate, a fourth C-coupling member and a fourth inductive filter line are further formed, wherein the fourth C-coupling member is spaced apart from the third C-coupling member and has a symmetric structure with the third C-coupling member, and wherein the fourth inductive filter line is connected to the fourth C-coupling member, is electrically connected to the second inductive filter line through a second via hole, and has a symmetric structure with the third inductive filter line.

8. A base station antenna radiator, comprising:
a first balun substrate, on an upper surface of which a feed line, a first C-coupling member spaced apart from the feed line, and a second C-coupling member spaced apart from the feed line and the first C-coupling member and having a symmetric structure with the first C-coupling member are formed, and on a lower surface of which a third C-coupling member opposite to the first C-coupling member and a fourth C-coupling member opposite to the second C-coupling member and having a symmetric structure with the third C-coupling member are formed, the first balun substrate being placed perpendicular to a reflector;
a second balun substrate coupled orthogonally to the first balun substrate, placed perpendicular to the reflector, and on which a metal pattern substantially identical to that of the first balun substrate is formed; and
a radiating substrate disposed above the first balun substrate and the second balun substrate, placed parallel to the reflector, and on an upper surface of which at least one radiating patch is formed,
wherein an end of the first C-coupling member is electrically connected to the radiating patch, and an end of the third C-coupling member is electrically connected to the reflector or an element having a ground potential.

9. The base station antenna radiator according to claim 8,
wherein on the upper surface of the first balun substrate, a first inductive filter line and a second inductive filter line are further formed, wherein the first inductive filter line is electrically connected to the first C-coupling member and has a narrower width than that of the first C-coupling member, and wherein the second inductive filter line is electrically connected to the second C-coupling member, has a narrower width than that of the second C-coupling member, and has a symmetrical structure with the first inductive filter line.

10. The base station antenna radiator according to claim 9,
wherein on the lower surface of the first balun substrate, a third inductive filter line and a fourth inductive filter line are further formed, wherein the third inductive filter line is electrically connected to the third C-coupling member and electrically connected to the first inductive filter line through a first via hole, and wherein the fourth inductive filter line is electrically connected to the fourth C-coupling member, is electrically connected to the second inductive filter line through a second via hole, and has a symmetrical structure with the third inductive filter line.

11. The base station antenna radiator according to claim 8,
wherein the first balun substrate and the second balun substrate include a first protrusion protruding upward, and the first protrusion protrudes above the radiating substrate through slots formed in the radiating substrate, and a first extension extending along the first protrusion is formed on the first C-coupling member and electrically connected to the radiating patch.

12. The base station antenna radiator according to claim 9,
wherein the first inductive filter line is formed extending from another end of the first C-coupling member.

13. The base station antenna radiator according to claim 11,
wherein the first balun substrate and the second balun substrate include a second protrusion protruding downward, and wherein a third extension of the third C-coupling member extends along the second protrusion and electrically connected to the reflector or the element having a ground potential.

14. The base station antenna radiator according to claim 8,
wherein a +45 degree polarization signal is fed to the feed line of the first balun substrate, and a −45 degree polarization signal is fed to the feed line of the second balun substrate.
